(19) United States
(12) Patent Application Publication
(10) Pub. No.: US 2024/0174837 A1
(43) Pub. Date: May 30, 2024

(54) POLYOLEFIN COMPOSITION HAVING IMPROVED ANTIBACTERIAL AND ANTIVIRAL PROPERTIES

(71) Applicant: SABIC GLOBAL TECHNOLOGIES B.V., BERGEN OP ZOOM (NL)

(72) Inventors: Ling Fan, Shanghai (CN); Abderrahmane Meddad, Riyadh (SA); Yahya Banat, Riyadh (SA); Jun Zhou, Shanghai (CN)

(21) Appl. No.: 18/284,382

(22) PCT Filed: Mar. 31, 2022
(86) PCT No.: PCT/EP2022/058585

§ 371 Date: Sep. 27, 2023

(30) Foreign Application Priority Data
Mar. 31, 2021 (WO) PCT/CN2021/084365

(51) Int. Cl. C08K 5/00; A01N 33/08; A01N 37/02; A01N 59/16; C08K 3/22; C08K 5/103; C08K 5/17

(52) U.S. Cl. CPC C08K 5/0091; A01N 33/08; A01N 37/02; A01N 59/16; C08K 3/22; C08K 5/103; C08K 5/17; C08K 2201/005

(57) ABSTRACT

A composition includes (a) a polyolefin preferably a polyethylene; and (b) a compound or formulation having an antiviral and antibacterial function, wherein such composition has an increased antiviral rate for H1N1, antiviral rate for Sars-Cov-2, antibacterial rate for E. Coli, and/or antibacterial rate for S. Aureaus.

### CROSS REFERENCE TO RELATED APPLICATIONS

This application is a National Stage application of PCT/EP2022/058585, filed Mar. 31, 2022, which claims the benefit of PCT Application No. PCT/CN2021/084365, filed Mar. 31, 2021, both of which are incorporated by reference in their entirety herein.

### BACKGROUND

The present invention relates to polyolefin compositions having improved antiviral and antibacterial properties. The invention further relates to articles comprising such polyolefin compositions, in particular to films comprising such polymer compositions.

Contamination with virus particles or bacteria that may lead to development of certain pathologies may occur via various routes, depending on the nature of the virus or bacteria. One method of particular relevance is via coming into contact with objects or surfaces that act as carriers for the virus particles or bacteria. In order for virus particles or bacteria to affect a recipient, whether it be an animal or a human being, in such way as to inflict a pathology, the recipient needs to be exposed to a certain quantity of particles of virus or bacteria, again depending on the nature of the virus or bacteria. it be clear that any reduction, in particular a significant reduction, of virus or bacteria on such object or surface will contribute to reduction of transmission of the pathology, thereby offering a technical effect that society desperately seeks to achieve.

For various hygienic and health-related purposes, there is a need to ensure that materials used in a variety of articles are of such constitution that their ability to serve as a breeding ground for viral particles and bacteria is as minimised as possible, as well as the ability to transmit virus particles or bacteria. Such articles that may transmit virus particles or bacteria are known as fomites.

### DETAILED DESCRIPTION

In many applications, and in many articles, polymer materials are used as material of choice for construing such article, or elements of such articles. Accordingly, it is appreciated that such polymer materials are of such nature that transmission of virus particles and/or bacteria is minimised to the greatest extent. For that reason, developments are occurring to provide polymer materials having desirably high antiviral and/or antibacterial properties.

It is preferred that the polymer composition has such antiviral and/or antimicrobial properties that an object produced using the polymer composition achieves an antibacterial rate of ≥98.0% on E. Coli, an antibacterial rate of 98.0 on S. Aureus, and/or an antiviral rate of 98.0 on H1N1. Preferably, the polymer composition achieves an antibacterial rate of 98.0% on E. Coli, an antibacterial rate of 98.0 on S. Aureus, and an antiviral rate of 98.0 on H1N1. Such polymer composition is considered to be particularly suitable for a variety of applications where certain hygienic demands are raised.

Furthermore, it is of great significance that such antiviral and antibacterial effects are achieved using compositions that are safe, allow for the production of products having properties not less of quality than commonly required for the product, that do not affect the production efficiency in production of such articles, and can be made ubiquitously available.

In accordance with the present invention, the inventors herein have now provided such composition, comprising
(a) a polyolefin; and
(b) a compound or formulation having an antiviral and antibacterial function.

In the composition according to the invention, (b) may for example comprise a compound according to the formula (I):

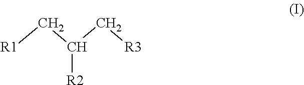

wherein each R1, R2 and R3 individually is a hydroxyl moiety or a moiety according to formula (II):

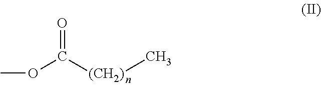

wherein n is an integer of ≥6 and ≤25;
and wherein at least one of R1, R2 and R3 is a hydroxyl moiety;
or mixtures thereof.

Ingredient (b) in the composition may for example be a mixture comprising a quantity of a compound of formula (I) wherein one of R1, R2 and R3 is a hydroxyl moiety, and a quantity of a compound of formula (I) wherein two of R1, R2 and R3 are hydroxyl moieties. Preferably, ingredient (b) in the composition is a mixture comprising ≥30.0 wt % and ≤95.0 wt % of a compound of formula (I) wherein one of R1, R2 and R3 is a hydroxyl moiety, and 3.0 wt % and ≤70.0 wt % of a compound of formula (I) wherein two of R1, R2 and R3 are hydroxyl moieties, with regard to the total weight of ingredient (b) in the composition. For example, ingredient (b) in the composition may be a mixture comprising ≥35.0 wt % and ≤50.0 wt % of a compound of formula (I) wherein one of R1, R2 and R3 is a hydroxyl moiety, and ≤65.0 wt % of a compound of formula (I) wherein two of R1, R2 and R3 are hydroxyl moieties, with regard to the total weight of ingredient (b) in the composition. For example, ingredient (b) in the composition may be a mixture comprising ≥55.0 wt % and ≤70.0 wt % of a compound of formula (I) wherein one of R1, R2 and R3 is a hydroxyl moiety, and ≤45.0 wt % of a compound of formula (I) wherein two of R1, R2 and R3 are hydroxyl moieties, with regard to the total weight of ingredient (b) in the composition.

In the compound of formula (I), it is preferred that n is an integer of ≥10 and ≤25, more preferably of ≥15 and ≤25, even more preferably of ≥15 and ≤20.

Ingredient (b) may comprise a glycerol monoalkanoate, a glycerol dialkanoate, or a mixture comprising a glycerol monoalkanoate and a glycerol dialkanoate. Ingredient (b) may for example comprise a mixture of glycerol monoalkanoate and glycerol dialkanoate, wherein the mixture comprises ≥30.0 and ≤95.0 wt % of the glycerol monoalkanoate, and preferably ≥3.0 and ≤70.0 wt % of the glycerol dialkanoate. Ingredient (b) may for example comprise a mixture of glycerol monoalkanoate and glycerol dialkanoate, wherein the mixture comprises ≥35.0 and ≤50.0 wt % of the glycerol monoalkanoate, and ≤65.0 wt % of the glycerol dialkanoate. Ingredient (b) may for example comprise a mixture of glycerol monoalkanoate and glycerol dialkanoate, wherein the mixture comprises ≥55.0 and ≤70.0 wt % of the glycerol monoalkanoate, and ≤45.0 wt % of the glycerol dialkanoate.

In the compound of formula (I) or mixtures thereof as used in ingredient (b), it is preferred that the alkanoate moieties are each the same and are selected from 1-octanoate, 1-nonanoate, 1-decanoate, 1-undecanoate, 1-dodecanoate, 1-tridecanoate, 1-tetradecanoate, 1-pentadecanoate, 1-hexadecanoate, 1-heptadecanoate, 1-octadecanoate, 1-nonadecanoate, 1-eicosanoate, 1-heneicosanoate, 1-docosanoate, 1-tricosanoate, and 1-tetracosanoate, preferably wherein the alkanoate moieties are selected from 1-hexadecanoate, 1-octadecanoate, and 1-eicosanoate.

Ingredient (b) may for example comprise a glycerol monostearate, a glycerol distrearate, or a mixture comprising a glycerol monostearate and a glycerol distrearate. Ingredient (b) may for example comprise a mixture of glycerol monostearate and glycerol distearate, wherein the mixture comprises ≥30.0 and ≤95.0 wt % of the glycerol monostearate, and preferably ≥3.0 and ≤70.0 wt % of the glycerol distearate. Ingredient (b) may for example comprise a mixture of glycerol monostearate and glycerol distearate, wherein the mixture comprises ≥35.0 and ≤50.0 wt % of the glycerol monostearate, and ≤65.0 wt % of the glycerol distearate. Ingredient (b) may for example comprise a mixture of glycerol monostearate and glycerol distearate, wherein the mixture comprises ≥55.0 and ≤70.0 wt % of the glycerol monostearate, and ≤45.0 wt % of the glycerol distearate.

The composition according to the invention preferably comprises ≥1.0 and ≤5.0 wt %, preferably >2.5 and <4.0 wt %, of the compound of formula (I) or mixtures thereof, with regard to the total weight of the composition. For example, the composition may comprise 1.0 and s 5.0 wt %, preferably >2.5 and <4.0 wt %, of a mixture of glycerol monoalkanoate and glycerol dialkanoate, wherein the mixture comprises ≥30.0 and ≤95.0 wt % of the glycerol monoalkanoate, and preferably ≥3.0 and ≤70.0 wt % of the glycerol dialkanoate. For example, the composition may comprise 1.0 and ≤5.0 wt %, preferably >2.5 and <4.0 wt %, of a mixture of glycerol monostearate and glycerol distearate, wherein the mixture comprises ≥30.0 and ≤95.0 wt % of the glycerol monostearate, and preferably ≥3.0 and ≤70.0 wt % of the glycerol distearate. For example, the composition may comprise 1.0 and ≤5.0 wt %, preferably >2.5 and <4.0 wt %, of glycerol monostearate.

In the composition according to the invention, (b) may for example comprise titanium dioxide. Preferably, the composition comprises ≥1.0 and ≤5.0 wt %, more preferably >2.5 and <4.0 wt %, of the titanium dioxide, with regard to the total weight of the composition. The titanium dioxide may for example have an average particle size defined as D₅₀ determined by laser diffraction dry method test on Malvern MASTERSIZER 3000 of ≥100 and ≤1000 nm, preferably of ≥500 and ≤1000 nm, more preferably of ≥500 and ≤800 nm.

In certain embodiments of the invention, ingredient (b) may comprise 1-hydroxy-2-pyridinethione zinc salt in such amount that the composition comprises ≥0.1 and ≤1.0 wt % thereof, preferably ≥0.1 and ≤0.5 wt %, with regard to the total weight of the composition.

In a further embodiment, ingredient (b) may comprise a compound of formula (III):

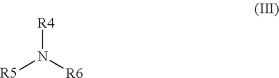

wherein each R4, R5 and R6 individually is an alkyl moiety, preferably a straight-chain alkyl moiety, preferably a straight chain alkyl moiety having 5 to 25 carbon atoms, or an alkoxy moiety, preferably an alkoxy moiety having 1 to 10 carbon atoms;
wherein at least one of R4, R5 and R6 is an alkyl moiety, and preferably wherein at least one other of R4, R5 and R6 is an alkoxy moiety;
in such amount that the composition comprises ≥0.1 and ≤1.0 wt % thereof, preferably ≥0.1 and ≤0.6 wt %, with regard to the total weight of the composition.

For example, the compound of formula (III) may be bis(2-hydroxyethyl)octadecylamine.

The polyolefin as used in the composition according to the invention may for example be selected from a low-density polyethylene, a polyethylene plastomer, a polyethylene elastomer, a linear low-density polyethylene, a medium-density polyethylene, a high-density polyethylene, or a polypropylene, or combinations thereof.

In the context of the present invention, the low-density polyethylene, also referred to as LDPE, may be understood to be a homopolymer of ethylene, or a copolymer comprising ≥70.0 of moieties derived from ethylene, wherein the LDPE is a polymer obtained via free-radical polymerisation.

The LDPE can be produced via high-pressure polymerisation, for example by polymerisation in tubular reactors or autoclave reactors, at a pressure of ≥150 MPA, more preferably ≥200 MPa, such as ≥200 and ≤300 MPa.

The LDPE may for example have a density of ≥890 and ≤930 kg/m³, preferably of ≥905 and ≤925 kg/m³. The LDPE may for example have a melt mass-flow rate as determined at 190° C. under a load of 2.16 kg of ≥0.5 and ≤25.0 g/10 min, preferably of ≥0.5 and ≤10.0 g/10 min, more preferably of ≥1.0 and ≤5.0 g/10 min.

In the context of the present invention, the polyethylene plastomer, also referred to as POP, may be understood to be a copolymer of ethylene and an α-olefin comonomer selected from propylene, 1-butene, 1-hexene, 4-methyl-pentene, 1-octene, and mixtures thereof. Preferably, the α-olefin comonomer may selected from 1-butene, 1-hexene and 1-octene.

The POP may for example comprise 5.0 and ≤30.0 wt % of moieties derived from the comonomer, preferably ≥10.0 and ≤20.0 wt %, with regard to the total weight of the POP. The POP may for example comprise ≥70.0 and ≤95.0 of moieties derived from ethylene, preferably ≥80.0 and ≤90.0 wt %. Preferably, the POP comprises ≥5.0 and ≤30.0 wt %, preferably ≥10.0 and ≤20.0 wt %, of moieties derived from the comonomer, and ≥70.0 and ≤95.0 wt %, preferably ≥80.0 and ≤90.0 wt %, of moieties derived from ethylene, wherein the comonomer is selected from 1-butene, 1-hexene and 1-octene.

The POP may for example have a density of ≥850 and ≤875 kg/m³, preferably of ≥855 and ≤875 kg/m³. The POP may for example have a melt mass-flow rate as determined at 190° C. under a load of 2.16 kg of 0.5 and ≤25.0 g/10 min, preferably of ≥0.5 and ≤10.0 g/10 min, more preferably of ≥1.0 and ≤5.0 g/10 min.

In the context of the present invention, the polyethylene elastomer, also referred to as POE, may be understood to be a copolymer of ethylene and an α-olefin comonomer selected from propylene, 1-butene, 1-hexene, 4-methyl-pentene, 1-octene, and mixtures thereof. Preferably, the α-olefin comonomer may selected from 1-butene, 1-hexene and 1-octene.

The POE may for example comprise ≥5.0 and ≤30.0 wt % of moieties derived from the comonomer, preferably ≥10.0 and ≤20.0 wt %, with regard to the total weight of the POE. The POE may for example comprise ≥70.0 and ≤95.0 of moieties derived from ethylene, preferably ≥80.0 and ≤90.0 wt %. Preferably, the POE comprises ≥5.0 and ≤30.0 wt %, preferably ≥10.0 and ≤20.0 wt %, of moieties derived from the comonomer, and ≥70.0 and ≤95.0 wt %, preferably ≥80.0 and ≤90.0 wt %, of moieties derived from ethylene, wherein the comonomer is selected from 1-butene, 1-hexene and 1-octene.

The POE may for example have a density of ≥876 and ≤900 kg/m³, preferably of ≥885 and ≤900 kg/m³. The POE may for example have a melt mass-flow rate as determined at 190° C. under a load of 2.16 kg of ≥0.5 and ≤25.0 g/10 min, preferably of ≥0.5 and ≤10.0 g/10 min, more preferably of ≥1.0 and ≤5.0 g/10 min.

In the context of the present invention, the linear low-density polyethylene, also referred to as LLDPE, may be understood to be a copolymer of ethylene and an α-olefin comonomer selected from propylene, 1-butene, 1-hexene, 4-methyl-pentene, 1-octene, and mixtures thereof. Preferably, the α-olefin comonomer may selected from 1-butene, 1-hexene and 1-octene.

The LLDPE may for example comprise ≥5.0 and ≤30.0 wt % of moieties derived from the comonomer, preferably ≥10.0 and ≤20.0 wt %, with regard to the total weight of the LLDPE. The LLDPE may for example comprise ≥70.0 and ≤95.0 of moieties derived from ethylene, preferably ≥80.0 and ≤90.0 wt %. Preferably, the LLDPE comprises ≥5.0 and ≤30.0 wt %, preferably ≥10.0 and ≤20.0 wt %, of moieties derived from the comonomer, and ≥70.0 and ≤95.0 wt %, preferably ≥80.0 and ≤90.0 wt %, of moieties derived from ethylene, wherein the comonomer is selected from 1-butene, 1-hexene and 1-octene.

The LLDPE may for example have a density of ≥901 and ≤925 kg/m³, preferably of ≥910 and ≤925 kg/m³. The LLDPE may for example have a melt mass-flow rate as determined at 190° C. under a load of 2.16 kg of ≥0.5 and ≤25.0 g/10 min, preferably of ≥0.5 and ≤10.0 g/10 min, more preferably of ≥1.0 and ≤5.0 g/10 min.

In the context of the present invention, the medium-density polyethylene, also referred to as MDPE, may be understood to be a copolymer of ethylene and an α-olefin comonomer selected from propylene, 1-butene, 1-hexene, 4-methyl-pentene, 1-octene, and mixtures thereof. Preferably, the α-olefin comonomer may selected from 1-butene, 1-hexene and 1-octene.

The MDPE may for example comprise ≥1.0 and ≤15.0 wt % of moieties derived from the comonomer, preferably ≥2.0 and ≤10.0 wt %, with regard to the total weight of the MDPE. The MDPE may for example comprise ≥85.0 and ≤99.0 of moieties derived from ethylene, preferably ≥90.0 and ≤98.0 wt %. Preferably, the MDPE comprises ≥1.0 and ≤15.0 wt %, preferably ≥2.0 and ≤10.0 wt %, of moieties derived from the comonomer, and ≥85.0 and ≤99.0 wt %, preferably ≥90.0 and ≤98.0 wt %, of moieties derived from ethylene, wherein the comonomer is selected from 1-butene, 1-hexene and 1-octene.

The MDPE may for example have a density of ≥926 and ≤940 kg/m³, preferably of 930 and ≤940 kg/m³. The MDPE may for example have a melt mass-flow rate as determined at 190° C. under a load of 2.16 kg of ≥0.5 and ≤25.0 g/10 min, preferably of ≥0.5 and ≤10.0 g/10 min, more preferably of ≥1.0 and ≤5.0 g/10 min.

In the context of the present invention, the high-density polyethylene, also referred to as HDPE, may be understood to be a homopolymer of ethylene, or copolymer of ethylene and an α-olefin comonomer selected from propylene, 1-butene, 1-hexene, 4-methyl-pentene, 1-octene, and mixtures thereof. Preferably, the α-olefin comonomer may selected from 1-butene, 1-hexene and 1-octene.

The HDPE may for example comprise ≥1.0 and ≤10.0 wt % of moieties derived from the comonomer, preferably ≥2.0 and ≤5.0 wt %, with regard to the total weight of the HDPE. The HDPE may for example comprise ≥90.0 and ≤99.0 of moieties derived from ethylene, preferably ≥95.0 and ≤98.0 wt %. Preferably, the HDPE comprises ≥1.0 and ≤10.0 wt %, preferably ≥2.0 and ≤5.0 wt %, of moieties derived from the comonomer, and ≥90.0 and ≤99.0 wt %, preferably ≥95.0 and 598.0 wt %, of moieties derived from ethylene, wherein the comonomer is selected from 1-butene, 1-hexene and 1-octene.

The HDPE may for example have a density of ≥941 and ≤975 kg/m³, preferably of ≥941 and ≤965 kg/m³. The HDPE may for example have a melt mass-flow rate as determined at 190° C. under a load of 2.16 kg of ≥0.5 and ≤25.0 g/10 min, preferably of ≥0.5 and ≤10.0 g/10 min, more preferably of ≥1.0 and ≤5.0 g/10 min.

In the context of the present invention, the polypropylene, also referred to as PP, may be understood to be a propylene homopolymer, a copolymer of propylene with an α-olefin or a heterophasic propylene copolymer.

Preferably, the polypropylene chosen from the group of propylene homopolymers and propylene copolymers comprising moieties derived from propylene and one or more comonomers chosen from the group of ethylene and alpha-olefins with ≥4 and ≤12 carbon atoms.

Preferably, the propylene copolymer comprises moieties derived from one or more comonomers chosen from the group of ethylene and alpha-olefins with ≥4 and ≤12 carbon atoms in an amount of ≤10 wt %, for example in an amount of ≥1.0 and ≤7.0 wt % based on the propylene copolymer, wherein the wt % is determined using ¹³C NMR. For example, the propylene copolymer comprises moieties derived from one or more comonomer chosen from the group of ethylene, 1-butene, 1-pentene, 1-hexene, 4-methyl-1-pentene, 1-heptene, 1-octene, 1-decene and 1-dodecene, preferably moieties derived from ethylene.

Polypropylenes and the processes for the synthesis of polypropylenes are known. A propylene homopolymer is obtained by polymerizing propylene under suitable polymerization conditions. A propylene copolymer is obtained by copolymerizing propylene and one or more other comonomers, for example ethylene, under suitable polymerization conditions.

Propylene homopolymers, propylene copolymers and heterophasic propylene copolymers can be made by any known polymerization technique as well as with any known polymerization catalyst system. Regarding the techniques, reference can be given to slurry, solution or gas phase polymerizations; regarding the catalyst system reference can be given to Ziegler-Natta, metallocene or single-site catalyst systems. All are, in themselves, known in the art.

Preferably, the polypropylene has a melt mass flow rate ≥0.50 and ≤8.0 g/10 min, more preferably ≥0.70 and ≤5.0 g/10 min, most preferably ≥1.0 and ≤4.0 g/10 min as determined in accordance with ASTM D1238 (2013) at a temperature of 230° C. under a load of 2.16 kg.

In the context of the present invention, the density of a polyolefin may be determined in accordance with ASTM D792 (2008). The melt mass-flow rate may be determined in accordance with ASTM D1238 (2013). The weight-average molecular weight M_{w} and the number-average molecular weight Mₙ may be determined in accordance with ASTM D6474 (2012). The content and type of comonomer may be determined using ¹³C Nuclear Magnetic Resonance on a Bruker Avance 500 spectrometer equipped with a cryogenically cooled probe head operating at 125° C., whereby the samples are dissolved at 130° C. in C₂D₂Cl₄ containing DBPC as stabiliser.

The composition may for example comprise 80.0 wt % of the polyolefin, preferably 90.0 wt %, more preferably ≥90.0 and ≤99.9 wt %, of the polyolefin, with regard to the total weight of the composition.

In certain embodiments, the present invention also relates to an article comprising the composition, preferably wherein the article is a film, a sheet, or a moulded object.

The invention also relates to the use of a compound according to formula (I)

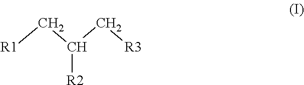

wherein:
each R1, R2 and R3 individually is a hydroxyl moiety or a moiety according to formula (II):

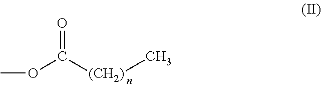

wherein n is an integer of ≥6 and ≤25;
and wherein at least one of R1, R2 and R3 is a hydroxyl moiety;
or mixtures thereof;
   to increase the antiviral rate for H1N1, the antiviral rate for Sars-Cov-2, the antibacterial rate for E. Coli, and/or the antibacterial rate for S. Aureaus, of a polyolefin composition, preferably of a polyethylene composition.

A further embodiment of the invention also relates to the use of an article comprising the composition according to the invention according to claim 15 to reduce the bacterial and/or viral transmitting capabilities of a fomite, preferably to reduce the H1N1 transmitting capabilities, the Sars-Cov-2 transmitting capabilities, the E. Coli transmitting capabilities, and/or the S. Aureaus transmitting capabilities.

Determination of antibacterial or antiviral rate in accordance with the present invention may be performed by using the method of ISO 21702 (2019) for H1N1, and the method of ISO 22196 (2011) for E. Coli and S. Aureus, wherein the antiviral rate c.q. the antibacterial rate is determined via the equation:

$$AR = \frac{R}{{A}_{t}} * 100 \%$$

wherein AR is the antiviral rate or the antibacterial rate, as the case may be, and wherein R and Aₜ are determined as per the methods of ISO21702 or ISO 22196, as the case may be.

The invention will now be illustrated by the following non-limiting examples.

In the experiments that were conducted in the work related to the present invention, the materials as listed in table I below were used.

TABLE I
Materials

| LLDPE | Supeer 8115, a linear low-density polyethylene, |
|---|---|
| | obtainable from SABIC |
| GMS40 | Glycerol monostearate, 40%, obtainable from Fanhua |
| | Chemical |
| GMS100 | Glycerol monostearate, 100%, obtainable from Riken |
| | Vitamin Co. as Rikemal S-100A |
| TiO₂-A | Titanium dioxide, Kronos 2233, average particle size |
| | 500-800 nm, obtainable from Kronos |
| TiO₂-B | Astra 4050, PE master batch obtained from Astra |
| | Polymer compounding Co. |
| AS1800 | Armostat 1800, obtainable from Nouryon |
| HPT-Zn | 1-hydroxy-2-pyridinethione zinc salt, CAS reg. nr. |
| | 13463-41-7 |

Using the above materials, blends were firstly prepared according to below table reprices on twin-screw extruder Coperion ZSK 26 Mc, with below temperature profile.

| Zone 1 | Zone 2 | Zone 3 | Zone 4 | Zone 5 | Zone 6 | Zone 7 |
|---|---|---|---|---|---|---|
| 20° C. | 40° C. | 160° C. | 160° C. | 170° C. | 170° C. | 180° C. |
| | | | | Die | Screw | |
| Zone 8 | Zone 9 | Zone 10 | Zone 11 | Temp | speed | Throughput |
| 180° C. | 200° C. | 200° C. | 200° C. | 200° C. | 300 rpm | 15 kg/h |

Single-layer films having a thickness of 50 μm were produced using a Labtech LF400-COEX blown film machine with die gap 2 mm. The processing condition was 210° C., blow-up ratio of 2.5, and with 5 kg/h output, according to the formulations in table 11 below.

TABLE II
Experimental formulations

| | | | | TiO₂- | TiO₂- | | HPT- |
|---|---|---|---|---|---|---|---|
| Example | LLDPE | GMS40 | GMS100 | A | B | AS1800 | Zn |
| 1 | 100.0 | | | | | | |
| 2 | 94.0 | | 3.5 | 2.5 | | | |
| 3 | 96.5 | | 1.0 | 2.5 | | | |
| 4 | 96.8 | | 0.7 | 2.5 | | | |
| 5 | 98.0 | | 2.0 | | | | |
| 6 | 96.5 | | 3.5 | | | | |
| 7 | 97.5 | | | 2.5 | | | |
| 8 | 96.5 | | | | 3.5 | | |
| 9 | 98.0 | | | | 2.0 | | |
| 10 | 96.5 | 3.5 | | | | | |
| 11 | 98.0 | 2.0 | | | | | |
| 12 | 95.5 | 2.0 | | 2.5 | | | |
| 13 | 94.0 | 3.5 | | 2.5 | | | |
| 14 | 97.0 | | | 2.5 | | 0.5 | |
| 15 | 99.9 | | | | | 0.1 | |
| 16 | 99.7 | | | | | | 0.3 |

The values in the table 11 represent wt % with regard to the total weight of the formulation.

Using the films produced as per above for each of the formulations of table II, the antiviral and antibacterial properties were determined according to the method as described above. The results of the determination of antiviral and antibacterial properties are presented in table III below.

TABLE III
Antiviral and antibacterial properties of films

| Example | H1N1 | E. Coli | S. Aureus |
|---|---|---|---|
| 1 | 55.2 | 0.0 | 46.9 |
| 2 | 99.2 | 98.7 | 99.8 |
| 3 | 93.4 | 41.0 | 76.7 |
| 4 | 21.2 | 78.0 | 40.0 |
| 5 | 86.7 | 76.0 | 90.0 |
| 6 | — | 96.6 | 95.4 |
| 7 | — | 1.7 | 99.9 |
| 8 | 90.6 | 20.0 | 43.8 |
| 9 | 90.8 | 0.0 | 54.4 |
| 10 | >99.9 | 99.9 | 98.4 |
| 11 | 99.2 | 57.6 | 99.6 |
| 12 | 79.0 | 52.5 | 41.7 |
| 13 | 68.7 | 42.4 | 95.8 |
| 14 | >99.9 | >99.9 | >99.9 |
| 15 | — | 57.6 | >99.9 |
| 16 | 99.1 | 99.9 | >99.9 |

In the above table, the values present the antiviral rate or antibacterial rate AR, in %, as determined according to the method outlined in the description.

1. A composition comprising
(a) a polyolefin; and
(b) a compound or formulation having an antiviral and antibacterial function.

2. The composition according to claim 1, wherein (b) comprises a compound according to formula (I): 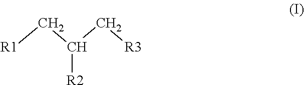
wherein each R1, R2 and R3 individually is a hydroxyl moiety or a moiety according to formula (II): 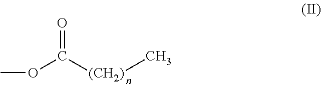
wherein n is an integer of ≥6 and ≤25;
and wherein at least one of R1, R2 and R3 is a hydroxyl moiety;
or mixtures thereof.

3. The composition according to claim 1, wherein (b) comprises a glycerol monoalkanoate, a glycerol dialkanoate, or a mixture comprising a glycerol monoalkanoate and a glycerol dialkanoate.

4. The composition according to claim 3, wherein the alkanoate moieties are each the same and are selected from 1-octanoate, 1-nonanoate, 1-decanoate, 1-undecanoate, 1-dodecanoate, 1-tridecanoate, 1-tetradecanoate, 1-pentadecanoate, 1-hexadecanoate, 1-heptadecanoate, 1-octadecanoate, 1-nonadecanoate, 1-eicosanoate, 1-heneicosanoate, 1-docosanoate, 1-tricosanoate, and 1-tetracosanoate.

5. The composition according to claim 3, wherein (b) comprises a mixture of glycerol monoalkanoate and glycerol dialkanoate, wherein the mixture comprises ≥30.0 and ≤95.0 wt % of the glycerol monoalkanoate.

6. The composition according to claim 2, wherein the composition comprises ≥1.0 and ≤5.0 wt %, of the compound of formula (I) or mixtures thereof, with regard to the total weight of the composition.

7. The composition according to claim 1, wherein (b) comprises titanium dioxide.

8. The composition according to claim 7, wherein the composition comprises ≥1.0 and ≤5.0 wt %, of the titanium dioxide, with regard to the total weight of the composition.

9. The composition according to claim 7, wherein the titanium dioxide has an average particle size of ≥100 and ≤1000 nm, and the average particle size is defined as D₅₀ determined by laser diffraction dry method test on Malvern MASTERSIZER 3000.

10. The composition according to claim 1, wherein (b) comprises 1-hydroxy-2-pyridinethione zinc salt in such amount that the composition comprises ≥0.1 and ≤1.0 wt % thereof, with regard to the total weight of the composition.

11. The composition according to claim 1, wherein (b) comprises a compound of formula (III): 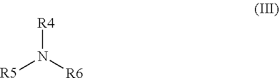
wherein each R4, R5 and R6 individually is an alkyl moiety, or an alkoxy moiety;
wherein at least one of R4, R5 and R6 is an alkyl moiety;
in such amount that the composition comprises ≥0.1 and ≤1.0 wt % thereof, with regard to the total weight of the composition.

12. The composition according to claim 11, wherein the compound of formula (III) is bis(2-hydroxyethyl)octadecylamine.

13. The composition according to claim 1, wherein the polyolefin is selected from a low-density polyethylene, a polyethylene plastomer, a polyethylene elastomer, a linear low-density polyethylene, a medium-density polyethylene, a high-density polyethylene, or a polypropylene, or combinations thereof.

14. The composition according to claim 1, wherein the composition comprises ≥80.0 wt % of the polyolefin, with regard to the total weight of the composition.

15. Article comprising the composition of claim 1.

16. (canceled)

17. (canceled)

18. The composition of claim 4, wherein the alkanoate moieties are selected from 1-hexadecanoate, 1-octadecanoate, and 1-eicosanoate.

19. The composition of claim 5, wherein the mixture comprises ≥3.0 and ≤70.0 wt % of the glycerol dialkanoate.

20. The composition of claim 11, wherein at least one of R4, R5 and R6 is an alkyl moiety, and preferably wherein at least one other of R4, R5 and R6 is an alkoxy moiety.

21. The composition of claim 1, wherein the composition comprises ≥90.0 and ≤99.9 wt %, of the polyolefin, with regard to the total weight of the composition.
